(19) United States
(12) Patent Application Publication
(10) Pub. No.: US 2006/0179136 A1
(43) Pub. Date: Aug. 10, 2006

(54) Accuracy of the estimation of computer resource usage

(76) Inventors: Charles Zdzislaw Loboz, West Ryde NSW (AU); Dean Peter Harding, Seven Hills NSW (AU); Jonatan Kelu, Granville NSW (AU); Dmitri Tchikine, Stanhope Gardens NSW (AU); Julian Charles Watts, Thornleigh NSW (AU)

Correspondence Address: UNISYS CORPORATION, UNISYS WAY, MAILSTOP E8-114, BLUE BELL, PA, 19424-0001, US

(21) Appl. No.: 10/540,909

(22) PCT Filed: Dec. 27, 2002
(86) PCT No.: PCT/US02/41432

§ 371 Date: Jun. 24, 2005

(51) Int. Cl. G06F 15/173

(52) U.S. Cl. 709/224

(57) ABSTRACT

The present invention provides a method and system (1) for improving the accuracy of an estimate of computing system resource usage, the method comprising the steps of obtaining utilization data of system resource and first transaction count data, obtaining further transaction count data and processing the transaction count data and further transaction data to provide an improved estimate of the number of transactions executed during a given time interval.

### FIELD OF THE INVENTION

The present invention relates to a system and method for estimating computer resource usage and specifically, but not exclusively, to a system and method for improving the accuracy of the estimation of computer resource usage by transaction types for transaction processing systems.

### BACKGROUND OF THE INVENTION

Resource usage estimation is becoming critical to modern computing systems. The advent of sophisticated multi-tasking and multi-threading operating systems and applications has allowed many transaction types to be executed concurrently on a single computing system.

A computing system may execute many transactions during a normal “day”. In a computing system, transactions may be grouped into subsets termed transaction types. These transaction types refer to functions or procedures carried out by the computer system. For example, there may be a function that calculates the stock level of a particular item, which may be designated by a name such as “stock-level”. In another example, there may be provided a function that generates a new order, and may be designated by a name such as “new-order”. Transactions belonging to the same type will usually have similar processing profiles. That is, transactions belonging to the same type will usually use a similar proportion of system resources. Information on the usage of computer resources by given transaction type is important. It allows a programmer or system administrator to determine the main causes of system resource consumption and thereby attempt to optimise certain transaction types, or to optimise hardware and/or software components of the system. Such optimisation preferably results in an improvement in overall efficiency.

In many computer systems that process transactions, there is generally provided a log to which transaction processing information is written. The log generally contains both individual transaction data and summary data, which is written to the log at the conclusion of a defined time interval. Such logs can be used to estimate resource usage by transaction types. A user, operator or administrator may, for example, wish to ascertain how much CPU time an average transaction uses. It will be understood that operating systems also provide data such as processor and disk utilisation statistics (commonly expressed as the percentage of the resource used at any given time interval).

The standard method for estimating CPU usage per transaction for a given period of time would be to select the time period, find the CPU usage in that period, find the number of transactions in the log for that period, and divide the CPU usage by the number of transactions. This provides a simple value of the amount of time used by the CPU to process a transaction.

The applicant has found that the usefulness of information computed by this simplistic method is low for a number of reasons.

Firstly, a transaction may take more than one time interval to execute. However, the transaction is only “counted” in the time interval where processing of the transaction was finalised.

In other words, during any given time interval, there are potentially two sources of inaccuracy due to transactions crossing the interval boundary:

1. transactions which begin execution during a previous time interval (that is, at least a portion of their CPU usage occurs in the preceding time interval—yet they are counted against the current time interval).

2. transactions which begin execution during the current time interval, but do not finish in the current time interval (these transactions utilise some CPU in the current time interval but they are not counted in the current time interval).

These inaccuracies will balance out over a long time period (i.e. over a large number of time interval samples). However, these inaccuracies will distort the instantaneous compuated CPU usage/transaction count ration. Additionally, there are many situations where data cannot be collected over a long time period. For example, in “live run” or “online” computing systems, a peak of user activity may only occur for a short defined time, or activity may be erratic.

The above prior art method does not deal with individual transaction types (e.g. “stock-level” and “new-order”). However, different transaction types may require different quantities of computer resources. For example, the time taken to execute the transaction “stock-level” may be different from the time taken to execute the transaction “new-order”. It would be useful to determine resource requirements for each transaction type.

The problem outlined above was identified by the applicant in a previous patent application, PCT 09/110,000, filed Mar. 14, 2002 in the United States Patent Office, which is incorporated herein by reference. The previous patent application discloses a method for determining an estimate of computer resource usage for different transaction types by collecting suitable statistical data and applying a least squares algorithm to the statistical data to provide an estimate of the resources used by an individual transaction type in a transaction mix, which preferably provides a solution to this problem. However, this method does not address the problem of concurrently accounting for transactions which cross the interval boundary, as discussed above.

### SUMMARY OF THE INVENTION

In a first aspect, the present invention provides a method of improving the accuracy of an estimate of computing system resource usage, comprising the steps of, obtaining utilisation data of a system resource, obtaining first transaction count data, wherein the first transaction count data provides an indication of the number of transactions executed in a given time interval, obtaining further transaction count data, wherein the further transaction count data contains additional information relating to the execution time of a transaction, and processing the transaction count data and the further transaction count data, wherein the processed data provides an improved estimate of the number of transactions executed during a given time interval.

To increase the accuracy of the estimate of CPU usage/transaction count ratio, the applicants, in at least a preferred embodiment, take into account the timeline of transactions that cross the interval boundary of a time interval.

The present invention preferably provides for a more accurate estimation of resource usage for individual transaction types by collecting further information with regard to the time interval during which a transaction is executed. It will be understood that the term “execution” refers to the time interval during which a transaction is utilising computing resources.

Similarly, the term “executed” will be understood to refer to a transaction which has finished execution (i.e. the transaction is no longer utilising computing resources).

The applicant has determined that the prior art approach in the referenced PCT 09/110,000 may be inaccurate in certain situations since the execution time for a transaction may span two or more time intervals, yet the transaction is generally only logged or “counted” when the execution is finished, creating the impression that the transaction executed in only one time period. The applicant proposes the collection of further transaction count data to more accurately determine the true execution time of a particular transaction.

Preferably, in a first embodiment, the further transaction count data comprises a data set containing a count of the total number of transactions which have not finished execution within a given time interval.

In the first embodiment, where the first transaction count data records the time interval in which a transaction finished executing, the further transaction count data comprises a data set containing a count of the total number of transactions which are currently being processed within the given time interval, but have not finished execution during that time interval (i.e. the transaction has not finished processing at the time that the “snapshot” is taken).

The further transaction count data is collected, in the first embodiment, by providing a further transaction count mechanism in the form of a counter for each transaction type. When a snapshot is taken (i.e. at the end of a time interval), the counter for each transaction type will be incremented by one unit for each transaction of that type which has not finished execution.

This provides further data (in conjunction with the first transaction data), of the time interval/s in which a transaction is executing. Thus, if a transaction begins execution in one time interval, but finishes execution in another time interval, the counter will log or count this discrepancy, and the information gathered is used to adjust the “processed” data accordingly. This method has the advantage that it is cheap to implement computationally (ie. it imposes only a minor burden on computing resources). This mechanism can be implemented in “real-time” without adversely affecting system load. Thus, with the first embodiment of the invention, it is possible to improve the accuracy of the transaction count data sourced from run-time systems working in real life environments.

Preferably, processing includes the further step of allocating the count of the total number of transactions, by an appropriate proportion, between an adjacent time interval and the given time interval.

Preferably, the appropriate proportion is 0.5.

In an application of the first embodiment of the present invention, the count data for each transaction type is allocated across two adjacent time intervals. That is, it is assumed that, for each transaction in processing at the moment of the snapshot, approximately half of the resources used to process the transaction are allocated to the given time interval and half to the adjacent time interval.

In other words, 0.5 counts is allocated to the transaction count in which execution of the transaction began, and 0.5 counts is allocated to the given time interval, in which the transaction was completed.

In a second embodiment, the further transaction count data comprises a data set containing the actual start time and the actual finish time for each transaction.

Preferably, the data set is processed to determine a proportion of time expended by a transaction within the given time interval and an adjacent time interval.

In a situation where system load is not a critical factor, a more accurate measurement mechanism may be used. In this second embodiment, every transaction start time and finish time is logged or counted, thereby allowing an operator to determine the exact proportion of a transaction that should be allocated to a particular time interval.

This can be contrasted with the first embodiment, where the counter only records the occurrence of an event within a given time interval. (ie. the start of a transaction). However, it does not record the time at which the transaction began. Therefore, whilst the first embodiment records the fact that a transaction has spanned two time intervals, it provides no information on how this time should be divided between the two intervals. The second embodiment, by tracking the exact start time and finish time of every transaction, allows the user to calculate the proportion of each transaction time that should be allocated to respective time intervals.

In a third embodiment, the further transaction data comprises a data set obtained by calculating the average transaction processing time for a given transaction type, and using the average transaction processing time to derive an estimate of the transaction time to be allocated to an individual transaction within a given time interval. The third embodiment collects, for each transaction, further transaction data that includes the start time of that transaction and for each transaction type, the average response time. The average response time is calculated by collecting the sum of the actual response times of a particular transaction type for a large number of events, and then calculating the average response time from this information. At the snapshot time (ie. the time at which the resource estimate is computed), the average time used by the transactions in processing for each transaction type is computed and the current average response time for this transaction type is determined.

Finally, the two values are divided to obtain the fraction of the transaction already executed. The fraction of the response time is then allocated across the two time intervals.

The third embodiment preferably improves the accuracy of the estimation of total resource usage for individual transaction types. It uses a different approach for estimating the effects of transactions whose processing time spans the interval time. Operationally and implementationally the cost of the third embodiment falls between the first and the second embodiments of the present invention. The accuracy of the third embodiment also falls between the accuracy of the first and second embodiments. This intermediate method can be used for “online” systems as it only moderately impacts on total system load.

Preferably, the above method comprises the further step of applying a mathematical model to the estimate of the number of transactions to provide an estimate of resource usage for individual transaction types within the computing environment.

In accordance with any embodiment of the present invention, the method disclosed in this document may be applied to further improve the results given by a method such as the one outlined in PCT 09/110,000, filed Mar. 14, 2002, in the U.S. Patent Office.

In PCT 09/110,000, there is disclosed a method for estimating the resource usage by individual transaction types, by collecting data relating to the number of transactions executed within a given time interval, and applying a least squares algorithm to isolate the resources used by an individual transaction type. The present invention may be used to further improve the accuracy of the resultant data produced by the invention disclosed in the above-mentioned application.

In a second aspect, the present invention provides a computing system arranged to facilitate the estimation of resource usage within a computer environment, comprising a data gathering means arranged to gather utilisation data of a computer resource and first transaction count data, wherein the first transaction count data provides an indication of the number of transactions executed in a given time interval, further data gathering means arranged to gather further transaction count data, wherein the further transaction count data contains additional information relating to the execution time of a transaction, and processing means arranged to process the first transaction count data and the further transaction count data, whereby the processed data provides an improved estimate of the number of transactions executed during a given time interval.

In a third aspect, the present invention provides a computer program arranged, when loaded on a computing system, to implement a method in accordance with the first aspect of the invention.

In accordance with a fourth aspect of the present invention, there is provided a computer readable medium providing a computer program in accordance with the third aspect of the present invention.

### DETAILED DESCRIPTION OF THE DRAWINGS

Features and advantages of the present invention will become apparent from the following description of an embodiment thereof, by way of example only, with reference to the accompanying drawings, in which;

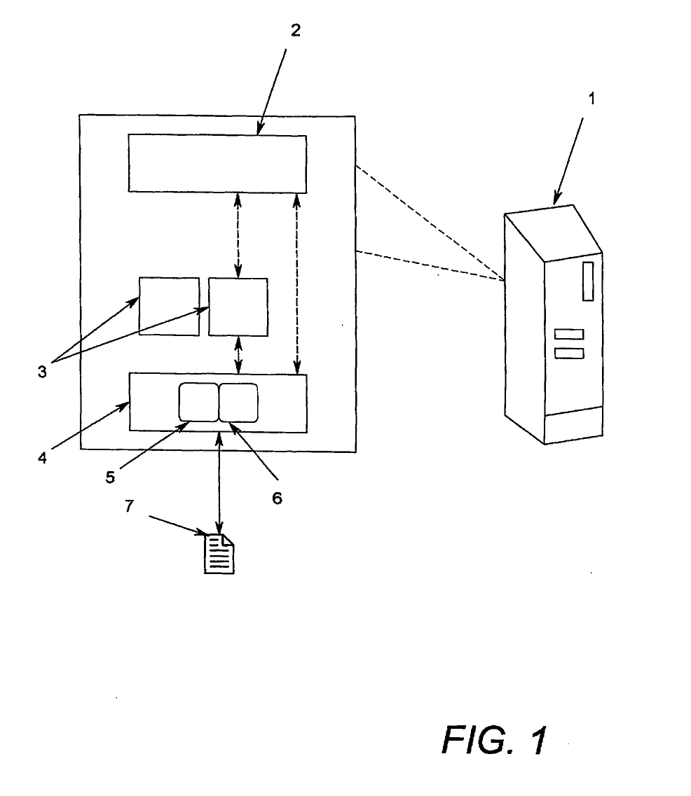

FIG. 1 illustrates a system for implementation of an embodiment of the present invention;

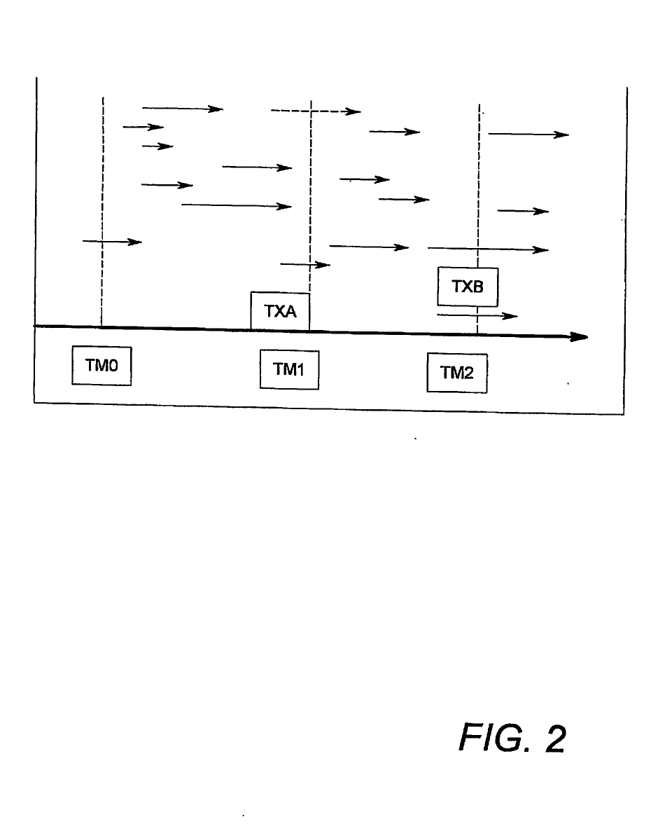

FIG. 2 is a time line diagram illustrating an example occurrence of transactions in relation to time intervals.

### DESCRIPTION OF THE PREFERRED EMBODIMENTS

The present invention broadly relates to a system and a corresponding method that preferably allows for an improved accuracy in the estimation of computer resource usage by transaction types for a transaction processing system.

In particular, an embodiment of the present invention applies to an Enterprise Application Environment, which may be implemented on a Windows™ or Unix™ platform. The term Enterprise Application Environment will be understood to mean a proprietary type of operating environment developed by Unisys Corporation and arranged to process many user requests at once. Moreover, other embodiments could equally be applied to any generic computing system arranged to process a large number of simultaneous user requests, such as a database application server, or a web server. It will also be understood that the present invention may be used in any computing system, whether the computing system consists of a single processor, or multiple processors or any other combination of hardware components, such as single or multiple storage drives.

In the following paragraphs, a simple example is used to illustrate the problem addressed by at least one embodiment of the present invention.

In many computer systems which process simultaneous user requests, there is generally provided a log to which transaction processing information is written. To minimise the logging overhead, the logging function will only write to the log file a single total of transaction counts for a given time interval (for example, at 5 second or 30 second interval). A sample log appears in Table I:

TABLE I
A sample log from a transaction processing system

| | |
|---|---|
| 05:40:00 | === total tx count 5 |
| 05:40:14 | TxPayment (terminal 01) |
| 05:40:33 | TxCustomerInquiry (terminal 08) |
| 05:40:58 | TxStockLevel (terminal 03) |
| 05:41:00 | === total tx count 8 |
| 05:41:03 | TxStockLevel (terminal 05) |
| 05:41:34 | TxPayment (terminal 08) |
| 05:41:45 | TxCustomerStatus (terminal 02) |
| 05:42:00 | === total tx count 11 |
| 05:42:05 | TxDelivery |

This log contains both individual transaction data (in the table, the letters ‘tx’ are an abbreviation for the word ‘transaction’) and summary data that is written to the log at the conclusion of each time interval. Such logs can be used to estimate resource usage. A user, operator or administrator may wish to ascertain how much, say, CPU time an average transaction uses. It will be understood that operating systems also provide data such as processor and disk utilisation statistics (commonly expressed as the percentage of the resource used at any given time interval). An embodiment of the present invention may be equally applied to measure any such statistic relating to any computer system resource.

In the prior art, the standard method for estimating, say, CPU resource usage per transaction for given period of time is:
Select time period: from 05:41:00 to 05:42:00
Determine the CPU resource usage in that period (say, 10 seconds of CPU time was used)
Determine the number of transactions in the log for that period (in our example: 3)
Divide the CPU resource usage by the number of transactions: 10/3=3.333
Therefore, average CPU/transaction is 3.333 seconds

The usefulness of information computed by this simplistic method is low for an important reason. A transaction may take more than one time interval to execute, yet, the transaction is only “counted” in the interval in which processing of the transaction was finalised. For example, the transaction which finishes at 05:41:03 (TxStockLevel (terminal 05) in Table I) could have started execution at 05:40:50. In such a situation, a large proportion of the transaction execution (and therefore CPU resource usage) would have occurred in the preceding time interval.

Therefore, during any given time interval, there are two potential sources of inaccuracy:
transactions which begin execution during a previous time interval (that is, a least a portion of the CPU resource usage occurs in the preceding time interval—yet the transaction is only counted in the current time interval).
transactions which begin during the current time interval, but do not finish in the current time interval (these transactions utilise some CPU resources in the current time interval but they are not counted in the current time interval).

Such inaccuracies will balance out over a long time interval (i.e. over a large number of time interval samples). However, these inaccuracies will distort the computed CPU usage/transaction count ratio.

A method commonly used to reduce this problem is to compute the average CPU/transaction ratio for an entire test “set” of data (or to use much larger interval times to reduce the number of transaction which cross an interval boundary). These approaches yield more accurate information, and are sufficient. For example, when the user is only interested in gross, ball-park figures. However, there are at least two situations where this approach does not yield satisfactory results.

Firstly, this approach is not satisfactory where precise data on the variability of CPU/transaction ratio with time and/or load is needed. Most computer systems require more CPU time to process the same transaction under high load than under low load (this is caused by the extra processing used by locking, back-off algorithms, queue management, etc).

Secondly, this approach is not satisfactory where estimates of CPU time used by individual transaction types is needed. This is due to the fact that in a multi-user, multi-tasking and multi-threaded computing system, several transactions (each transaction potentially being a different transaction type) will be processed concurrently, such that the true time taken by a transaction of a particular type may be masked or distorted by the concurrent processing of other different transaction types. Thus, the prior art only allows a user to calculate an average transaction time for a mixed “basket” of transactions, and not for each individual transaction type. This is disadvantageous, since different transaction types will use different resources.

It will be understood that the preceding description refers to “CPU usage” (or “CPU utilisation”) as an example of a computer resource. In the context of the present invention, the phrase “CPU utilisation” will be understood to mean a value which represents a quantitative measurement of the CPU resources used by any transaction or action performed by an operating system or other software application. The use of a “CPU resource” could include, by way of example only, the loading of variables into the CPU register, the performing of arithmetic functions by the CPU, the flushing of on-board CPU cache, or any other function which is performed exclusively by the CPU and prevents other transactions from accessing or using the CPU.

The utilisation value could also represent any appropriate hardware or software resource, such as individual processes or functions within a larger application, or different applications residing concurrently on a computing system. It will be understood that any system resource may be measured, such as input/output parameters, number of context switches, network usage, etc.

FIG. 2 illustrates an example timeline of transaction execution and data collection. The horizontal axis denotes time, and each arrow in the diagram denotes an individual transaction, the start and end point of each arrow denoting the start and end of the execution time of each transaction. The vertical lines denote the time at which each “snapshot” is taken.

The most natural (frequently the only) method for collecting data in any computer system is to increment a transaction counter each time a transaction finishes. This results in a situation where, for example, the method in the applicants previous application PCT 09/110,000 counts all the transactions which finish in a given time interval as if they were executed during the time interval.

However, this methodology is not always correct. This inaccuracy is illustrated by the transactions marked txₐ and tx_{b}, at the bottom of FIG. 1, at time intervals, respectively, Tm1 and Tm2:
The txₐ transaction is counted as occurring in the time interval Tm1:Tm2, although a part of the execution time (and resource usage) occurs in the previous (Tm0:Tm1) time interval.
The tx_{b} transaction is not counted in the time interval Tm1:Tm2, as it finishes after Tm2—yet the tx_{b} transaction uses resources in the Tm1:Tm2 time interval.

Thus with typical transaction counting methodology, transactions are ascribed solely to a given interval, even though computer resources in the preceding interval were used. Moreover, the reverse situation is also possible. That is, transactions that finish in the next interval are not counted in the present interval.

Therefore, there is a basic inaccuracy in the data collected—while the measurements of, say, processor utilisation is accurate (to clock resolution) for a given interval, the transactions counts are not accurate. This inaccuracy is inherent in the way computer systems behave and are measured. Transactions arrive randomly from multiple users/sources. Therefore it is not possible (in principle) to ensure that transaction execution will never cross the interval boundary. Regardless of how the time interval between measurements is chosen, there will always (statistically) be transactions that begin their execution in one time interval and finish in another time interval.

The inaccuracy of resource usage estimates is high if many transactions are split between intervals—that is, when the time intervals are short and transaction processing time is long.

Therefore this inaccuracy increases the error of the estimate of resource usage by each transaction type. The original method will yield satisfactory results if a statistically significant number of samples is gathered—i.e. when enough data is collected. However, improving accuracy is important for several reasons:

Firstly, it would enable an operator, during system testing, to obtain more accurate data from shorter test runs (thus saving computer and time) which can then be translated into more accurate estimates of resource time usage.

Secondly, in production systems it enables “fine-grain” estimates of transaction resource usage, within shorter periods of time. Note that in production systems there is only a very limited possibility of extending the measurement time period. When peak hour traffic is measured, and the peak lasts, say, one hour, then this is the only data available, and maximum benefit must be delivered from this limited data set.

This improvement preferably enables the use of small time intervals (thereby providing more accurate measurements) by reducing the effect of boundary conditions (split transactions).

In order to obtain an estimate of system resource usage for each transaction type, the method disclosed in the earlier application (namely PCT 09/110,000, filed before the United States Patent and Trademark Office on Mar. 14, 2002) can be used. The method disclosed in PCT 09/110,000 will now be briefly discussed.

The number of transactions of each type executed in the time period are collected in the log, as is the processor utilisation. Sample raw data is shown in Table II below:

TABLE II
Sample CPU utilisation data and transaction counts

| Time | CPU_util | NnewOrder | NStockLevel | nDelivery |
|---|---|---|---|---|
| 10:35:10 | 0.985 | 3 | 2 | 1 |
| 10:35:19 | 0.743 | 5 | 3 | 4 |
| 10:35:31 | 0.650 | 8 | 3 | 6 |
| 10:35:40 | 0.344 | 10 | 4 | 7 |

Table II is, in effect, an overdetermined system of equations (that is, a system of simultaneous equations that contain sufficient information to be solved by application of the appropriate methodology), in the form A*X=B, where B represents the product of the first and second columns of the table. The product of the first and second columns of the table provides a measure of the time (in milliseconds) taken by the CPU to process the transactions listed in the corresponding row. The matrix A represents a matrix comprising the remaining columns of the table. That is, matrix A contains the number of transactions processed within a given period of time, the transactions being grouped by process type. The matrix A, as derived from the data presented in Table II, is shown in table III.

TABLE III
The matrix ‘A’, as derived from the data given in Table II
$A = [ \begin{matrix}3 & 2 & 1 \\ 5 & 3 & 4 \\ 8 & 3 & 6 \\ 10 & 4 & 7\end{matrix} ]$

The vector X represents a vector of coefficients giving the usage for each transaction type.

This overdetermined set of equations may be solved by the standard linear least squares solution:
X=(A^{T}*A)−*(A^{T}*B)

The linear least squares method solution embodied in the above equation is a well known method which is described in many undergraduate text books. See, for example, [Johnson et al “Applied Multivariate Statistical Analysis” 3rd ed Practice Hall].

A solution to a system of equations in accordance with the above method is disclosed in PCT 09/110,000, filed Mar. 14, 2002 in the United States Patent Office. An example of the method disclosed in PCT 09/110,000 is outlined below.

In accordance with an example given in PCT 09/110,000, a sample of data gathered (i.e. the first transaction data) is shown below in table IV.

TABLE IV
Sample transaction and time interval data

| CPU[ms] | Tx1 | Tx2 | Tx3 |
|---|---|---|---|
| 195.417 | 4 | 2 | 2 |
| 261.513 | 6 | 3 | 1 |
| 31.6187 | 3 | 2 | 0 |
| 186.385 | 0 | 3 | 1 |
| 101.492 | 6 | 2 | 0 |
| 79.3373 | 0 | 3 | 1 |
| 340.892 | 5 | 3 | 1 |
| 245.999 | 2 | 3 | 0 |
| 123.910 | 1 | 0 | 2 |
| 50.4557 | 2 | 2 | 0 |

The matrix A is denoted by columns tx1, tx2 and tx3 of table IV.

$$A = [ \begin{matrix}4 & 3 & 2 \\ 6 & 3 & 1 \\ 3 & 2 & 0 \\ 0 & 3 & 1 \\ 6 & 2 & 0 \\ 0 & 3 & 1 \\ 5 & 3 & 1 \\ 2 & 3 & 0 \\ 1 & 0 & 2 \\ 2 & 2 & 0\end{matrix} ]$$

Matrix B represents the first column of the table (that is, the column marked “CPU”).

$$B = [ \begin{matrix}195.417 \\ 261.513 \\ 031.6187 \\ 186.385 \\ 101.492 \\ 079.3373 \\ 340.892 \\ 245.999 \\ 123.91 \\ 050.4557\end{matrix} ]$$

Therefore, substituting into the standard linear leased squared solution we obtain the following equation:

$$X = {( {[ \begin{matrix}4 & 3 & 2 \\ 6 & 3 & 1 \\ 3 & 2 & 0 \\ 0 & 3 & 1 \\ 6 & 2 & 0 \\ 0 & 3 & 1 \\ 5 & 3 & 1 \\ 2 & 3 & 0 \\ 1 & 0 & 2 \\ 2 & 2 & 0\end{matrix} ]}^{T} * [ \begin{matrix}4 & 3 & 2 \\ 6 & 3 & 1 \\ 3 & 2 & 0 \\ 0 & 3 & 1 \\ 6 & 2 & 0 \\ 0 & 3 & 1 \\ 5 & 3 & 1 \\ 2 & 3 & 0 \\ 1 & 0 & 2 \\ 2 & 2 & 0\end{matrix} ] )}^{- 1} * ( [ \begin{matrix}4 & 3 & 2 \\ 6 & 3 & 1 \\ 3 & 2 & 0 \\ 0 & 3 & 1 \\ 6 & 2 & 0 \\ 0 & 3 & 1 \\ 5 & 3 & 1 \\ 2 & 3 & 0 \\ 1 & 0 & 2 \\ 2 & 2 & 0\end{matrix} ] * [ \begin{matrix}195.417 \\ 261.513 \\ 31.6187 \\ 186.385 \\ 101.492 \\ 79.3373 \\ 340.892 \\ 245.999 \\ 123.91 \\ 50.4557\end{matrix} ] )$$

Solving this equation, we find that the values for X are,
X={13.0585, 39.2245, 50.4133},
suggesting that the processor usage for type 1 processes is approximately 13 ms, for type 2 processes the value is approximately 39 ms, and for type 3 processes the value is approximately 50 ms.

The present applicants have determined that the accuracy of the estimate obtained by the method outlined in PCT 09/110,000 may be improved by the collection of more accurate data with regard to the time intervals in which a transaction was executed.

To increase the accuracy of the estimate of CPU usage/transaction count ratio, the applicant has determined that it is necessary to take into account the timeline of transactions that cross the interval boundary on both ends of the time interval.

A system in accordance with an embodiment of the present invention is illustrated in FIG. 1.

There is shown a computing system 1 on which runs an operating system 2, and optionally other third party software applications 3.

An embodiment of the present invention 4, comprises a data gathering means 5 which interacts with either the operating system and/or the third party applications to gather transaction process data and raw system resource utilisation data.

The data gathering means may be implemented by appropriate software/hardware or by any convenient means known to the skilled person in the art, to collect data as required by the following description of an embodiment of the present invention.

The system also provides a further data gathering means 6, which collects further transaction data. This data is processed by a processing means 7 to provide a processed transaction count data 8 as output data. It will be understood that the further data gathering means may also be implemented by appropriate software/hardware or by any convenient means known to the skilled person.

In a first embodiment, there is provided a method for improving the accuracy of the estimation of resource usage per transaction type for systems in production—dubbed the ‘quick method’.

This method comprises:

Writing to the application log, at the end of each time interval, further transaction data comprising the number of transactions of each type in processing at the moment of the snapshot.
Assuming that for each transaction in processing at the moment of the snapshot used, approximately half of the resources are expended in the first time interval and the other half of the resources are expended in the following time interval.
Adjusting the transaction count in both time intervals by a value of 0.5.
Applying the least squares method to the augmented count values, in accordance with the earlier apparatus, to estimate resource usage per transaction type.

In the present example, the further transaction data is collected by the use of a cumulative counter. A cumulative counter represents a common practice in “real world” situations, since cumulative counters are simple to implement and run on computing systems.

The application log contains the total count of transactions that completed execution at each interval (ie. nPayment and nStockLev). For example, at clock interval 05, the transaction “nPayment” has occurred (and completed execution) 2 times. See table V below. In addition, transactions of each type in processing while the snapshot is taken (ie. pgpayment and pgStockLev) are also collected.

TABLE V
Sample application log

| Clock | CPU | nPayment | NStockLev | pgPayment | PgStockLev |
|---|---|---|---|---|---|
| 05 | 0.79 | 2 | 3 | 1 | 0 |
| 10 | 0.19 | 3 | 4 | 0 | 1 |
| 15 | 0.38 | 7 | 2 | 1 | 1 |

For the time interval finishing at 10 clock units, the values 3, 4 (corresponding to the total number of Payment and StockLevel transactions executed in the given time interval) are used in the system of equations in accordance with the applicants earlier patent application, namely PCT 09/110,000. Analysing the transactions in progress, there is one StockLevel transaction active at the time of the snapshot (pgStockLev at time 10 is 1).

Therefore, the StockLevel transaction count becomes 4+0.5=4.5.

There is no Payment transactions active at time 10, but there was one active at the end of the previous time interval (pgpayment at time 05 is 1). Therefore, one of the three Payment transactions executed in this time period began execution in the previous time period. So, the adjusted Payment transaction count is 3−0.5=2.5 Overall these adjustments change the original equation from
5*0.19=3*CPUPayment+4*CPUStockLevel
to
5*0.19=2.5*CPUPayment+4.5*CPUStockLevel
Applying the above considerations to all the rows in the table, an adjusted and more accurate system of equations is obtained, which is solved, in one embodiment, by the linear least squares method. In general terms the rules for adjusting transaction counts for each transaction type, in accordance with the first embodiment, are as follows:
Add 0.5 to transaction count for each transaction in progress during this time interval.
Subtract 0.5 from transaction count for each transaction in progress during the previous time interval.

This method requires collection of additional data—for each transaction type it is necessary to count the number of transactions in progress. In most systems such data can be collected easily and with a minimal run time overhead.

Therefore, this method is applicable to production systems, under normal working conditions.

This method preferably improves the accuracy of the resource use estimates, but it is assumed that the transaction in progress is evenly divided between two time periods. This is statistically true over a large sample, but for any given time period a transaction might be split in any proportion between the first and the second time. However, this method is attractive for systems that operate under high load conditions, as the method is simple to implement and only requires a minimal amount of computing resources.

In a second embodiment, there is provided a method for improving the accuracy of the estimation of computer resource usage particularly suited for systems in testing—dubbed the “full method”.

This method comprises:

Writing to the application log, for each executed transaction, the following further transaction count data: transaction type, start time and finish time.
After each test run, the further transaction count data is collated with snapshot times to obtain precise values of the portion of each transaction executed in each time interval.
The precise values derived are employed to adjust transaction counters.
The adjusted equations are solved using the same method employed in the first embodiment, preferably by using the linear least squares method.
   For example, if it is known that the transaction txₐ (from FIG. 2) started at 10:30:09 and finished at 10:30:13, then only 1 second of the transaction was executed in the previous time period (before 10:30:10) and 3 seconds were executed in the time period after 10:30:10. Therefore, the appropriate transaction counters can be adjusted by 0.25 and 0.75. (In practice the timings are collected and collated at millisecond level and much more precise adjustments of transaction counters can occur).

This approach provides the best possible accuracy, but it is costly in terms of computer resources. The logging of start-finish time of each transaction is required, which places run time overheads on the logging system (such as the I/O and CPU). Such data collation requires a significant amount of disk space, processor time and computer memory, which presently makes this method practical only for off-line analysis. This method may be primarily used in system benchmarking and/or testing, as it is unlikely that system administrators would allow such overhead in production systems on a routine basis.

Statistically this method provides a better approximation than the quick method.

In a third embodiment, there is provided a method for improving the accuracy of estimation of resource usage for systems in testing and in production—dubbed the “intermediate” method

The third approach to improve the accuracy of transaction counts is different from the “full method” and the “quick method”—it uses a different approach to estimating the effects of transactions in processing at the interval time. Operationally and implementationally the cost of the intermediate method falls between the ‘full’ and the ‘quick’ methods. The accuracy of the intermediate method also falls between the accuracy of the ‘full’ and ‘quick’ methods. The intermediate method can be used for systems in production, though some system administrators would probably not use it on a routine basis.

The intermediate method comprises:

Collecting, for each transaction, further transaction count data comprising a data set of the start time of the transaction (in memory), and the average response time (in memory).

At the snapshot time, the average time used by the transactions in processing for each transaction type is computed.
The current average response time for this transaction type is determined.
The two values are divided to obtain the fraction of the transaction already executed.
   This method requires fewer computer resources than the full method since:
It avoids collation of individual transaction response times with snapshot times, and hence it is uses fewer computing system resources than the full method.
It avoids logging each transaction start time to the file (log), which further reduces data collection overhead—especially in the input/output subsystem.
It requires only keeping in memory the start time of each transaction in progress (ie. unfinished transactions)—which is usually a small number, which requires only several kilobytes of memory.

The intermediate method can be used for systems in production and is effective enough for systems in testing. The intermediate method provides a better approximation of real transaction counts than the quick method but is not as accurate as the full method. The source of inaccuracy resides in the fact that the response times at the moment of the snapshot are only an approximation of response times of transactions in progress (while the full method uses actual rather than average response times).

It will be understood that whilst an embodiment of the present invention may be applied to the invention disclosed in PCT 09/110,000, filed Mar. 14, 2002, in the United States Patent Office, the present invention has broader application and may be applied to preferably improve the accuracy of any suitable resource usage estimation method.

In the abovementioned embodiments of the present invention, raw data is obtained from an application that is integral to a contemporary computer operating system, but it is to be understood that the data may be obtained in any appropriate way. For example, data may be obtained from a facility that is integral to the operating system, from a facility that is integral to an application residing on a computing system, or alternatively the data collection process may be a facility provided integrally with an embodiment of the present invention. Many contemporary operating systems allow a user to produce a “log” which contains information regarding the utilisation of one or more hardware resources.

It will be further understood that the data may be collected in a different form from the procedure outlined in the above examples. For example, it may be possible to collect data directly from the operating system, or directly from a hardware monitor.

Modifications and variations as would be apparent to a skilled addressee are deemed to be within the scope of the present invention.

1. A method of improving the accuracy of an estimate of computing system resource usage, comprising the steps of, obtaining utilisation data of a system resource, obtaining first transaction count data, wherein the first transaction count data provides an indication of the number of transactions executed in a given time interval, obtaining further transaction count data, wherein the further transaction count data contains additional information relating to the execution time of a transaction, and processing the transaction count data and the further transaction count data, wherein the processed data provides an improved estimate of the number of transactions executed during a given time interval.

2. A method in accordance with claim 1, wherein the further transaction count data comprises a data set containing a count of the total number of transactions that have not finished execution within a given time interval.

3. A method in accordance with claim 1, wherein the further transaction count data comprises a data set containing the start time and finish time for each transaction executed.

4. A method in accordance with claim 3, wherein the data set is processed to determine a proportion of time expended by a transaction within the given time interval and an adjacent time interval.

5. A method in accordance with claim 2, wherein processing includes the step of allocating the count of the total number of transactions, by an appropriate proportion, between an adjacent time interval and the given time interval.

6. A method in accordance with claim 5, wherein the appropriate proportion is 0.5.

7. A method in accordance with claim 1, wherein the further transaction data comprises a data set obtained by calculating the average transaction processing time for a given transaction type, and using the average transaction processing time to derive an estimate of the transaction time to be allocated to an individual transaction within a given time interval.

8. A method in accordance with any one of the preceding claims, wherein the method comprises the further step of applying a mathematical model to the estimate of the number of transactions to provide an estimate of resource usage for individual transaction types within the computing environment.

9. A computing system arranged to facilitate the estimation of resource usage within a computer environment, comprising a data gathering means arranged to obtain utilisation data of a computer resource and first transaction count data, wherein the first transaction count data provides an indication of the number of transactions executed in a given time interval, further data gathering means arranged to gather further transaction count data, wherein the further transaction count data contains additional information with regard to the execution time of a transaction, and processing means arranged to process the first transaction count data and the further transaction count data, whereby the processed data provides an improved estimate of the number of transactions executed during a given time interval.

10. A system in accordance with claim 9, wherein the further data gathering means is arranged to obtain count data comprising the total number of transactions that have not finished execution within a given time interval.

11. A system in accordance with claim 9, wherein the further data gathering means is arranged to log the start time and finish time for each transaction.

12. A system in accordance with claim 11, wherein the processing means is arranged to process the data set to determine a proportion of time expended by a transaction within the given time interval and an adjacent time interval.

13. A system in accordance with claim 10, wherein the processing means is arranged to allocate the count of the total number of transactions, by an appropriate proportion, between an immediately preceding time interval and the given time interval.

14. A method in accordance with claim 13, wherein the appropriate proportion is 0.5.

15. A system in accordance with claim 9, further comprising calculation means, arranged to calculate the average transaction processing time for a given transaction type, and further calculate an estimate of the transaction time to be allocated to an individual transaction within a given time interval.

16. A computer program arranged, when loaded on a computing system, to implement the method of any one of claims 1 to 8.

17. A computer readable medium providing a computer program in accordance with claim 16.
